(19) United States
(12) Patent Application Publication
(10) Pub. No.: US 2016/0251101 A1
(43) Pub. Date: Sep. 1, 2016

(54) Set Meal Packaging for Inflight Dining

(71) Applicant: K-ONE INDUSTRIES PTE. LTD., Singapore (SG)

(72) Inventors: Mun Chew Kong, Singapore (SG); Chze Seong Cheong, Singapore (SG)

(21) Appl. No.: 15/027,349

(22) PCT Filed: Oct. 8, 2014
(86) PCT No.: PCT/SG2014/000471

§ 371 Date: Apr. 5, 2016

(30) Foreign Application Priority Data
Oct. 8, 2013 (SG) 2013075338

(51) Int. Cl. B65B 65/00; B65B 67/02; G06Q 10/08; B65B 35/30

(52) U.S. Cl. CPC B65B 65/003; B65B 35/30; B65B 67/02; G06Q 10/087

(57) ABSTRACT

A method for packaging set meals includes a first step of providing service ware items, a second step of offering food, beverage or condiment items, a third step of preparing at least one configuration of set meal package, and a fourth step of assembling a set meal package according to the configuration automatically. A set meal packaging line includes one or more machine stations for loading food, beverage, condiment or cutlery items onto a tray, one or more conveyors for transferring the food, beverage, condiment or cutlery items. The one or more machine stations include an industrial robot.

The present application relates to one or more methods for set meal packaging, loading, ordering, distribution and storage. It also relates to one or more manufacturing lines for set meal packaging. The one or more manufacturing lines are also known as set meal assembly line(s), set meal packaging line(s), or simply meal packaging line(s). Packaged set meals may be provided for inflight dining or inflight catering.

An inflight catering centre is often required to provide set meals on trays with large quantities and varieties to numerous flights continuously and timely. The set meals are also known as tray assemblies, airline meals and in-flight meals. Preparation and packaging of the set meals are known to be complex, labour intensive and costly. Oversupply, delay, food wastage, hygiene problems and other mistakes in set meal handlings are common, which often tarnish reputation of airlines and their inflight catering centre(s).

The present invention(s) provides new, creative and useful methods for set meal packaging, loading, ordering, distribution and storage. The invention(s) also provides manufacturing lines for the set meal packaging, loading, ordering, distribution and storage. Essential features of the invention(s) are provided by independent claims, whilst advantages features are provided by their dependent claims. The present application claims priority of Singapore patent application 2013075338 that was filed on 8 Oct. 2013. All content of this earlier application is hereby incorporated by reference.

According an aspect of the invention, the present application provides a method for packaging set meals that comprises a first step of providing service ware items, a second step of offering food, beverage or condiment items, a third step of preparing one or more configurations of set meal packages, and a fourth step of assembling a set meal package according to the configuration automatically by one or more industrial robots. The industrial robot includes. Cartesian robot, Sacra robot, 6-axis robot, redundant robot, dual-arm robot, which may also be known as robotic arm. Some of these steps may be changed in sequence. For example, the first step and the second step may be changed in order. Here, the service ware items include nonedible or non-drinkable items for preparing the set meal packages. Examples of these items include cutlery items, serviette, trays, bowls, dishes, saucers, wine glasses, knives, forks, spoons, mugs, casseroles, tissue papers and toothpicks. In contrast, the food, beverage and condiment items contain cooked meat, noodles, rice, bread, yogurt, cup water, salt sachets, biscuit packs and chocolate bars.

The method provides predetermined programmed configuration(s) or programme for assembling meal sets. The configuration is in the form of computer or machine readable data, such as graphic images of set meal packages machine-readable codes, or other media readable by machine (e.g. magnetic disc/tape, punch card). Instead of using human to pick and place food and non-food items, the method avoid tedious, slow and repetitive actions by human operators. Instead, the method conjures an automatic assembly line that pack set meals according required quantity and configuration. The automation may be achieved by placing food or non-food items by using jigs (machine tools), sensors, industrial robots and machine visions to determine positions of the food and non-food items when assembling the set meal package. An automatic control system of computer(s) (e.g. programmable logic controller) may be used to programme and/or store desired configurations of the set meal packages as well as assigning tray in it respective carts and location inside the carts. The method alleviates laborious and monotonous work from operators such that reliability, accuracy, hygiene standard and packaging quality can be improved. Associated cost of packaging the set meals can be greatly reduced. Airline catering centres that adopt the method can save their manpower and physical space resources for providing more efficient and cost effective operations.

The step of preparing one or more configurations of the set meal package can comprise a step of storing identification information of the one or more configurations of set meal package. Various types or sets of meals can codified either as machine readable codes or human readable characters. The codification provides standard information of the meal sets such that machines or devices can automatically select and place food or non-food items onto trays for packaging. For example, bowls that have embedded RFID (Radio-Frequency Identification) chips allows automatic recognition by equipment with Automatic Identification and Data Capture (AIDC) technologies to manage logistic and packaging of the set meal packages according to the predetermined configurations. Machine recognition provides faster and more accurate actions for assembling the set meal packages.

The step of storing identification information of the one or more configurations of set meal package may comprise a step of keeping identification codes of the set meal package, service ware items of the set meal package, food item or the set meal package, beverage items of the set meal package, condiment items of the set meal package, cutlery items of the set meal package or a combination of any of these items. The identification codes may be stored in digital format onto computer-readable medium. For example, the identification code stored on a hard disk drive is readable by a local or remote computer. The same set of identification codes thus is possible to be accessed, edited, backuped (keeping a secure copy) by multiple computing devices. The stored identification codes allow standardisation of manufacturing process.

The step of storing identification information of the one or more configurations of set meal package can comprise a step of preserving images of the set meal package, service ware items of the set meal package, food item or the set meal package, beverage items of the set meal package, condiment items of the set meal package, cutlery items of the set meal package or a combination of any of these items. Since human process images much easier and faster, the images, either in analogue or digital format, provide convenience to machine operators for rapidly modifying or analysing predetermined patterns of set meal packages.

The step of preparing one or more configurations of set meal package or storing identification information of the one or more configurations of set meal package may comprise a step of establishing one or more digital libraries for keeping relevant information. The digital libraries are also known as databases that are accessible by computers. The digital libraries may be specialised for storing one type of objects (e.g. part library) or multiple types of objects (master library). For example, the digital libraries include service ware item library, aircraft library, cart library, menu library, flight destination library. The aircraft library provides information on number of seats for various aircrafts. The flight destination library contains information flight duration, which provides patterns of meals served. The menu library has information of different types of meal sets, which provides detailed food and non-food items for these various types. The digital libraries provide readily available data for designing set meals, ordering food items and requesting service ware items. Speedy, accurate and Just-In-Time (JIT) production strategy can be executed, which provides fresh and cost effective set meals to airline passengers.

The method can comprise a step of updating the one or more digital libraries. Since set meal configuration may be evolving, the digital libraries are updated for keeping up with customers' demand and logistic supply of food. Digital libraries of different airline catering centres can be configured and changed to suit local food supply and airline requirements. Accordingly, the set meal packages can be provided with flexibilities for meeting seasonal or consumer demands.

The method may comprise a step of installing a calculation and control programme for using the identification information to assemble the one or more meal packages automatically. The calculation and control programme can be in the form of an application software programme installed on a local computing server (e.g. computer or Personal Computer), a mobile app on a portable electronic device (e.g. tablet computer) or a web application installed on a remote sever. The calculation and control programme can alternatively be known as calculation and control logic that may be executed by one or more programmable logic controllers or computers (e.g. single-chip cloud computer). The installation may be performed by user(s), service provider(s) or vendor(s) of automatic set meal packaging lines.

The application software programme optionally comprises a graphical user interface (GUI) that allows operators to edit menus or configure assembling processes through graphical windows, icons and visual indicators, such as secondary notation. Actions in the GUI are performed through direct manipulation of the graphical elements, such as via the touchscreen of the computer server.

The method may optionally comprises a step of transferring, moving or inserting one or more assembled set meal packages into a cart or trolley according to relevant flight information, aircraft information, seating information or a combination of any of these. Since an airline may receive specific meal requirement before passengers' boarding, selected set meal packages are assembled and packaged into carts for subsequent catering to flight(s) of these passengers. Particularly, upon knowing seating arrangements of the passengers, the assembled set meals are packaged into specific carts that are assigned to relevant galleries or passages of these passengers in an aeroplane. The carts, the assembled set meals or both may have tags readable human (printed label) or machine (e.g. barcode or RFID chip) such that subsequent set meal handling becomes efficient and accurate.

The method can comprise a step of inspecting one or more items of the set meal package. Morden customers are demanding in set meal hygiene and packaging presentation. Inspection of individual food items and non-food item before their packaging prevents faulty items from making the set meals. Assembled set meal packages may be further subjected to inspection such that fractured or spilled set meal packages are prohibited from reaching dining tables of customers of airlines. Reputation and service quality of food caterers (e.g. airlines) are enhanced.

The step of inspecting may comprise a step of comparing images of the one or more item of the set meal package with the one or more configurations of set meal packages stored on a computer. The stored images provide standard configurations of food or non-food items according to predetermined quality standards. Comparison of these images and configuration (pictures) easily reveals faulty items for elimination. Accordingly, packaging quality of the set meals in mass production is not compromised or delayed.

The step of inspecting can further comprise a step of examining the one or more items of the set meal package with/by machine vision (MV). Machine vision is imaging-based automatic inspection and analysis for automatic inspection, process control, and robot guidance. The machine vision includes computer vision that includes methods for acquiring, processing, analysing, and understanding images. In general, machine or computer vision captures high-dimensional data from the food or non-food items for producing numerical or symbolic information, which in turn guide machines for taking decisions or actions. The machine vision provides fast and accurate quality control and guidance to set meal packaging such that human operators are alleviated from carrying out tedious and exhausting manual vision inspection.

The step of assembling a set meal package may comprise a step of picking one or more items of the set meal package by an industrial robot. The industrial robot may further transfer an empty tray from a cart or carries a packaged set meal to a cart. The industrial robot may additionally move trays, carts, food or non-food items or packaged meal sets to designated place(s) for machine-vision inspection or storage. The industrial robot obtains position (2D or 3D) and profile information of objects (e.g. food or non-food items) such that the transferring of the objects can be made fast and accurate. The industrial robot may operate continuously round the clock (around the clock) without failing in speed and accuracy, suitable for airline catering centres.

The step of picking the one or more items of the set meal package can comprise a step of inspecting the picked item with machine vision by using the industrial robot. In other words, the industrial robot has machine vision capability such that one or more of industrial robots can work independently or cooperatively for assembling the same set meal package. In one embodiment, the industrial robot has a camera on its arm or mounted above the industrial robot such that movements of the robotic arm are guided by images captured by the on-board camera.

The method may comprise a step of loading service ware items, food items, beverage items, condiment items or cutlery items to machine work stations for assembling the set meal package automatically. Since the service ware items, food items, beverage items, condiment items or cutlery items are supplied to the machine stations or at their receiving bays, the machine stations can pick stores of these items onto incoming trays for set meal packaging. Having stocks of these items prevents unnecessary waiting time for these work stations such that these work stations can place food or non-food items onto the trays continuously, without interruption. The work stations include both manual and machine (e.g. robotic) stations.

The method can further comprise a step of refusing one or more service ware items, food items, beverage items, condiment items or cutlery items for assembling the set meal package for quality compliance. When detecting faulty items, an industrial robot can swiftly remove the faulty item from the packaging line without hindering packaging operation. The refused item may be subsequently inspected manually for checking if it is caused by faulty machine or random error. The set meal packaging line is thus maintained with low rejection rate.

The method may further comprise a step of conducting self-examination of machine status to the set meal packaging line. The self-examination may involve sensors and computing server(s) for checking operational status of the set meal packaging line. For example, the self-examination includes checking if there is sufficient number of empty trays available at a tray loading station. The self-examination further may include a step of checking cameras of the set meal packaging line whether they can capture clear digital images. The self-examination prevents faulty start of machine operation, reducing loss in time or material.

The method can further comprise a step of sending on or repeated alarm signals when encountering issue for assembling the set meal package. The alarm signals may be received by a local operator or remote technician over internet. Both local and remote diagnosis may be executed when receiving the alarm signals. Therefore, maintenance of the set meal packaging line may be executed while the set meal packaging line is running, preventing time loss to catering centres.

The method may further comprise a step of suspending operation when encountering issue for assembling the set meal package. The operation suspension may be locally at one station or widely across several set meal packaging lines at a catering centre. The operation suspension may prevent serious disasters if major defects occur at the set meal packaging line or across several lines.

The step of preparing one or more configurations of set meal package can comprise a step of revising the one or more configurations according to set meal ordering information. Although airlines offer many types of set meals for selection by airline passengers, the method allow the airlines or airline catering centres to modify, change, correct, add or delete these set meal configurations for satisfying passengers' needs. The airlines may further allows the passengers to modify, design or create their own choices of set meal packages before their flights/travelling such that the customised set meal packages are timely packaged and ready for serving on-board for the relevant flights. The option of configuring set meal packages is particularly useful for passengers with medical or nutrition requirements (e.g. food allergies).

The method may further comprise a step of labeling the packaged set meal with the identification information or flight information for recording, handling or distribution. The step of labeling the set meals or carts that carry the set meals help the airlines to allocate carts to specific aircraft or galleries of the aircrafts according to relevant flights. Staffs of the airlines may counter-check assembled set meals or carts before delivering to the passengers according to the labeling. Wastage or error for set meal catering is substantially reduced. Passengers with food allergies are protected from mishandling of set meal packages.

The method can additionally comprise a step of changing an end effector of the industrial robot according to the one or more items of the set meal package. By prior instruction, configuration or (machine or computer) vision images, the industrial robot can exchange its end effector according to objects (e.g. food or non-food items) for packaging. For example, the industrial robot adopts a suction cup (astrictive end effector) for picking up a saucer, and uses jaws (impactive end effector) for capturing a cutlery package.

The method may further comprise a step of sending request to kitchen or store for replenishing tableware items, food items or trays to the set meal packaging line. The request may be automatically transmitted between computers or to human operators as a message. One or more staffs may deliver the tableware items, food items or trays manually or via an AGV (automated guided vehicle or automatic guided vehicle).

The method can further comprise a step of monitoring hygiene condition of set meal packaging. The hygiene condition of food items, non-food items or any machine parts can be achieved by vision inspection of these objects, or by biosensors. For example, a conveyor belt is found to be unhygienic if dark spots of larger than 2 mm (millimetre) diameters are detected. The biosensor includes an electronic nose that will send an alarm to the set meal packaging line or operators when detecting food decomposition (rotting). The biosensor may be independently connected to a local alarm/indicator/meter device or connected to a computer for monitoring hygiene condition of the set meal packaging line.

The step of monitoring hygiene condition may comprise a step of examining a conveyor belt, an end effector of an industrial robot, or any other parts of a set meal packaging line. The examination may be continuously, periodically or on demand carried out by vision inspection or biosensors. If found dirty, soiled parts may be automatically cleaned or replaced. For example, the conveyor belt is exposed under an array of steam jets such that the conveyor belt is cleansed by stem of 150° C. if found dirty. Similarly, a soiled end effector is rinsed or steam-cleaned automatically if found contaminated. Hence, the method can further comprises a step of cleaning or replacing an unhygienic conveyor belt, an unhygienic end effector of an industrial robot, or any other unhygienic parts of the set meal packaging line. The cleaning or replacing may be carried out periodically (regularly) or on demand.

The application further provides a method of supplying set meal packages for inflight dining, which can comprise the preceding method of packaging set meals, a step of receiving information on cart loading configurations, and a step of filling the carts with packaged set meals according to the configurations. Carts for specific flights often have predetermined positions in aircrafts. The present method provides carts that are loaded with the set meal packages according to passengers' locations/seating positions in their relevant aircrafts such that a cart of relevant alleys or galleries in an aircraft is filled with set meals for passengers seating along the alleys or galleries. Logistic management of set meal package distribution is drastically simplified. Both the airlines and airline catering centres will require less manpower for preparing and distributing the set meal packages, with improved delivery quality.

The step of filling the carts may further comprise step of arranging the packaged set meal packages according to seat booking information of one or more flights. Passengers can request, select, update or even create configurations of set meal packages before their flights. The method can prepare the assembled set meal packages and put them into carts of passengers' corresponding flights such that more freedom or choices are made available to the passengers, and the airlines are more adaptable to dynamic changes or requirements from the passengers.

According to another aspect of the invention, the present application provides a set meal packaging line that comprises one or more machine stations for loading food, beverage, condiment or cutlery items onto a tray, one or more conveyors or transporters for transferring the food, beverage, condiment or cutlery items. The one or more machine stations comprise an industrial robot. The industrial robot has configurations of articulated robots, SCARA robots, delta robots and/or Cartesian coordinate robots (gantry robots or x-y-z robots). The industrial robot carries out action with accuracy and speed such that the set meal packaging line provides excellent productivity.

The industrial robot can comprise a robotic arm that is mechanical arm. The robotic arm has various end effectors is programmable such that the robotic arm can adapt to or change to different tasks for packaging diverse types of food or non-food items. Thus, the robotic arm has the flexibility, speed and accuracy of moving food or non-food items when assembling set meal packages of dissimilar menus.

The set meal packaging line can include a labeling station for attaching tags or labels of identification to one or more assembled set meal packages or carts with the one or more assembled set meal packages. Labeling can be in the form of printing stickers, attaching tickets, writing codes/words onto trays or carts, producing barcodes, generating RFID chips or a combination of any of these. The labeling station may be detachable or incorporated into any of the existing stations. Any stations of the set meal packaging line can have reader(s) for interpreting information or codes of the labeling.

The robotic arm may have six degrees of freedom such that the robotic arm can pick and place both odd and regular shapes of food and non-food items. For example, the robotic arm is an articulated robot whose arm has three or more rotary joints. The robotic arm is small and versatile such that the set meal packaging line becomes compact and does not occupy large factory floor.

The set meal packaging line can further comprise one or more cameras connected to computing server(s) for capturing images of the food, beverage, condiment or cutlery items, or the tray. Images of these items are processed by computers such that the set meal packaging line can guide industrial robot(s) for capturing either stationary or moving food or non-food items accurately and swiftly. The set meal packaging line becomes highly efficient.

The set meal packaging line may further comprise one or more computing servers for examining the images of the food, beverage, condiment or cutlery items, or the tray against quality requirements. The one computing server may control a local set meal packaging line or several lines over a network. Alternatively, several computing servers of different lines are connected together in forming a wired/wireless network such that those lines can copperplate with each for packaging set meals for several airlines together.

The computing server can be connected to the industrial robot or other machine tools (e.g. programmable logic controller with jigs) for picking food or non-food items when assembling set meal packages according to the one or more predetermined set meal package configurations. Hence, the industrial robot becomes intelligent such that the industrial robot can pick food or non-food items according to the predetermined configurations by following relevant images or codes, whilst reject food or non-food items having defects (e.g. spillage or crack).

The computing server may comprise one or more communication ports for wired or wireless configuration. The communication ports include E-Sata, Firewire (IEEE1394 interface), PS/2, serial, USB, VGA, SCSI, HDMI and audio ports. The communication ports further include wireless communication ports, such as Wi-Fi, Bluetooth, ZigBee (IEEE 802.15 standard.) and other forms of wireless communication interfaces. These communication ports -provide convenience for computer network and local access, such as for configuration.

The computing server can be connected to one or more remote computing servers or computers for receiving set meal ordering, running Enterprise Data Warehouse or both. Through web portals, online application software packages, intranet or internet, the computing server receives and update set meal configurations and their quantities for assembling. Another computer or the same computing server can further perform data analytics for identifying trend, keeping records of specific passengers' preference, arranging external food supply to the catering centre. The set meal packaging can thus be integrated into catering centres' airlines' and external suppliers' managements for efficiency, accuracy and productivity. For example, a passenger can design and order his set meal before boarding, whilst the customised set meal will be ready for servicing to the passenger's seat, gallery, aircraft and flight in advance.

The set meal packaging line may further comprise a manual work station for assembling the set meal package. The manual station provides access to human operators for handling soft or odd objects such that the machine station(s) and manual handling can complement each other for handling diverse types of food and non-food items. In the words, the set meal packaging line possesses both advantages of human handling and machine operation.

According to a further aspect of the invention, the present application provides a set meal ordering system or device that comprises a frontend for receiving meal orders electronically, a backend connected to the front end for compiling the meal orders. The backend comprises a meal database server connected to the front end. The meal database server is configured to organise the meal orders according different groups.

The set meal ordering system or device enables customers to order or edit their set meals remotely (remote diagnose or servicing), via external computer terminals. For example, airlines, cruise liners, inflight caterers or airline passengers can order their meals via their own computing devices (e.g. Sever, Personal Computer, Tablet computers or smartphones) over the internet before their flights. Airline operators or cruise liner operators can offer wide variety of food to the passengers, whilst preparation of the set meals can still be centralised at their inflight catering centres. The set meal ordering system is suitable for airline operators, inflight catering centres, camps, cruise liners, restaurants, food/meal caterers, hotels, event/exhibition organisers, corporate meal organisers and other commercial organisations for providing packaged meals. Passengers or customers of airliners or cruise liners can book their set meals through websites or online systems for ordering the meals, which are subsequently fed into set meal assembly lines of caterer centres for automatic packaging of the set meals, such as by Flexible Assembly Lines for Tray Packaging (FAL-TA).

The Flexible Assembly Lines (FAL-TA) can perform constant tracking of items inside storage bins and send command electronically for refilling via operators or directly to Automated Guided Vehicle for picking the loaded bin from refilling station/food bank.

The application also provides a method of ordering set meals, which comprises a step of displaying options of set meals electronically or graphically for ordering, a step of receiving orders of set meals electronically from external computers, and a step of compiling the orders of set meals according to their groups.

The method seamlessly integrates consumers of the set meals into enterprise resource planning application systems and management. Meal caterers (e.g. airline operators) can meet a wide diversity of meal preferences efficiently, over different flight sectors, timely and at low cost. The inflight caterer or consumers can choose their preferences in advance (e.g. before flight), possibly receiving recommendation of healthy choices of food items.

The application further provides a set meal preparation system that comprises a meal logistic application server for receiving orders of set meals, and an inflight catering centre connected to the meal logistic application server for supplying the set meals. The inflight catering centre further comprises an automated meal tray packaging line for assembling the set meal onto trays.

The set meal preparation system causes backend operation of a flight catering centre to be automated for achieving high productivity and low cost. The items of the set meals are transmitted electronically (e.g. via internet or intranet) to the set meal packaging machine such that operators are relieved from labour intensive work. Airline operators or inflight catering centres become more responsive to customers' demand, satisfying their needs efficiently.

The application additionally provides a method of preparing set meal automatically which comprises a step of receiving orders of meal sets for a flight, a step of defining and categorising each and individual items appealing on the meal trays, a step of categorising types of the orders of meal sets, a step of distributing different types of meal sets to carts, and a step of packaging the meal sets automatically according to the order.

The method provides automatic distribution of resources (e.g. food items and service wares) in an inflight catering centre. Packaged set meals of wide diversity are further stored into carts in an orderly manner with various different configurations for different flights. Since the set meals are presented automatically, possibly with computerised systems, both the set meal preparation and inflight catering centre operation can be integrated into airport logistic system for improving overall efficiency and achieving low cost.

The set meal preparation system facilitates customers or passengers to select food of their choice for setting up or configure their own meal meats, preferably over internet website or mobile apps before taking their flights. For example, a passenger can visit airline website for accessing set meal ordering page. At the webpage, he can interact with graphic user interface by dragging or dropping food items for configuring his preferred food items. Packaged tray assemblies are thus labeled by barcode (linear or 2D) or RFID tag for tracking its food/drink contents, passenger name, seat number, cart number and flight number. Customers of airlines are thus enabled to choose their preferred food, avoid unwanted food or requesting special food items. Customisation of the set meals may be done by customers via their personal computing devices, such as Personal Computers, Tablet Computers, (e.g. iPad®), smartphones. The airlines can track preparation of set meals for quality management, cost control, customer feedback and logistic tracking.

According to an additional aspect, the present application provides a set meal ordering system/device that comprises a frontend for receiving meal orders electronically, and a backend connected to the front end for compiling the meal orders. The backend comprises a meal database server connected to the front end. The meal database server is configured to organise the meal orders according different groups.

The frontend can comprise a router for receiving the meal orders wirelessly. The frontend further may comprise a website hosting server for displaying information (options) of the set meals via an internet website. The frontend can alternatively further comprise one or more touchscreens for receiving the meal orders. The frontend may further comprise an airline ticket sales server connected to the meal database server for validating the meal orders.

According to yet a further aspect of the invention, the present application provides a method for ordering set meals. The method comprises a first step of displaying options of set meals for ordering, a second step of receiving orders of set meals electronically from external computers and, a third step of compiling the orders of set meals according to their groups. Some of these steps may be changed in order or sequence. The method may further comprise a step of recommending food items of the set meals.

The method can further comprise a step of transmitting the orders of set meals to suppliers of the set meals. The step of compiling may comprise a step of separating the meal orders according to flight numbers, meal types, food items, service ware items and times of set meal delivery. The method can further comprise a step of editing the orders of meal sets which comprises of three main sections namely:
a) Parts Library for Storing information of each individual items including, types, materials, pictures, dimensions, colour, ID, programmed surface defects and Robotic X-Y-Z coordinates for picking/unloading, and the like;
b) Meal Library for storing information of each different type of Tray meal configuration. It allows setting up (drag & drop), configures, locating the Parts in the tray, assigning of loading sequence, assigning robotic coordination, Meal ID, allowing editing, and the like;
c) Cart Library for storing information of how the assembled meal tray is being loaded inside the Meal Carts accordance to meal types, gallery, airline loading preference, and the like.

According to a yet additional aspect of the invention, the present application provides a set meal preparation system that comprises a meal logistic application server for receiving orders of set meals; and an inflight catering centre connected to the meal logistic application server for supplying the set meals. The inflight catering centre further comprises an automated meal tray packaging line for assembling the set meal onto trays.

The automated meal tray packaging line can comprise a control station for controlling a conveyor in order to transport trays. The control station or the meal logistic application server may further comprise a touchscreen for displaying a Homepage, a Menu Setting page, a Product Info page, a Maintenance Report page or an electronic part library in order to regulate the assembling of set meals.

The set meal preparation system may further comprise a modular work station for packaging the set meals according to predetermined programmes. The modular work station can comprise a tray-to-conveyor module, a conveyor, a first bin module, a second bin module, a third bin module, a first condiment module, a second condiment module, a carousal module, an inspection module or a combination of any of these modules.

A further aspect of the invention provides a method for preparing set meal automatically. The method comprises a first step of receiving orders of meal sets for a flight, a second step of categorising types of the orders of meal sets, a third step of distributing different types of meal sets to carts, and fourth step of packaging the meal sets automatically according to the order. Some of these steps may be changed in sequence.

The method can further comprise a step of selecting trays from an electronic part library for packaging the set meals. The method may further comprise a step of choosing service wares from the electronic part library. The method can further comprise a step of picking food items from the electronic part library. The method may further comprise a step of displaying the electronic part library graphically. The method can further comprise a step of computing the trays, the service wares or the food items of at least one flight for duty planning. The may further comprise a step of assigning predetermined packaging procedures to modules of a meal-tray assembly line for packaging the trays, the service wares or the food items.

The method can further comprise a step of providing production information of the meal-tray assembly line. The method may further comprise a step of monitoring status of the meal-tray assembly line for providing Maintenance Report. The method can further comprise a step of listing parameters of packaged set meals to the meal-tray assembly line, the meal database server, the meal logistic application server or the inflight catering centre.

An additional aspect of the invention provides a method for preparing meal tray assembly. The method comprises a first step of setting up parts; a second step of providing trays for receiving the parts; and a third step of arranging cart for holding the trays. Some of these steps may be changed in sequence. The step of setting up parts can comprise a step of providing service ware, food items or both. The present application provides a Meal Automated Tray Assembly System configured to perform any of the methods mentioned above.

The method or set meal packaging line allows airlines or passengers to order or select their set meals in advance. The airlines can perform statistical analysis and prepared their set meals according to flight route, flight time, flight origin, flight destination, seat position, dietary preference or passengers' preference. The application further provide a computing system that receives, stores, analyses, calculate set meal loading information based on the above-mentioned information such that preparation of set meal packages is more streamlined and automated for providing efficiency at lower cost.

The method or set meal packaging line has ability to print out tag/sticker that can be pasted or hooked to relevant carts and/or special meal trays showing flight number, and meal types. Additional tag or sticker may be attached to carts for indicating quantity and types of set meals inside the carts such that on-board stewards can easily locate specific set meal packages, without the need to search through each cart to look for the meal. The sticker on set meal packages or their trays also serve to prevent wrong meal served to passenger as some passenger maybe allergic to certain food and get sick seriously. The tag/sticker can have picture, icon or words for the stewards to cross-check the actual meal served to the passenger for food safety.

The application provides a computer system or software packages for collecting data of set meal packages, ordering information and flight information. The computer system or software package can further provide data analytics for marketing trends of caterers, which facilitates the design of future set meal packages (e.g. menu), meals and food preference and prevent food wastage.

Airlines or catering centres can provide mobile apps, websites or other online or offline communication means (e.g. telephone) for conducting meals satisfaction survey.

The accompanying figures (Figs.) illustrate embodiments and serve to explain principles of the disclosed embodiments. It is to be understood, however, that these figures are presented for purposes of illustration only, and not for defining limits of relevant inventions.

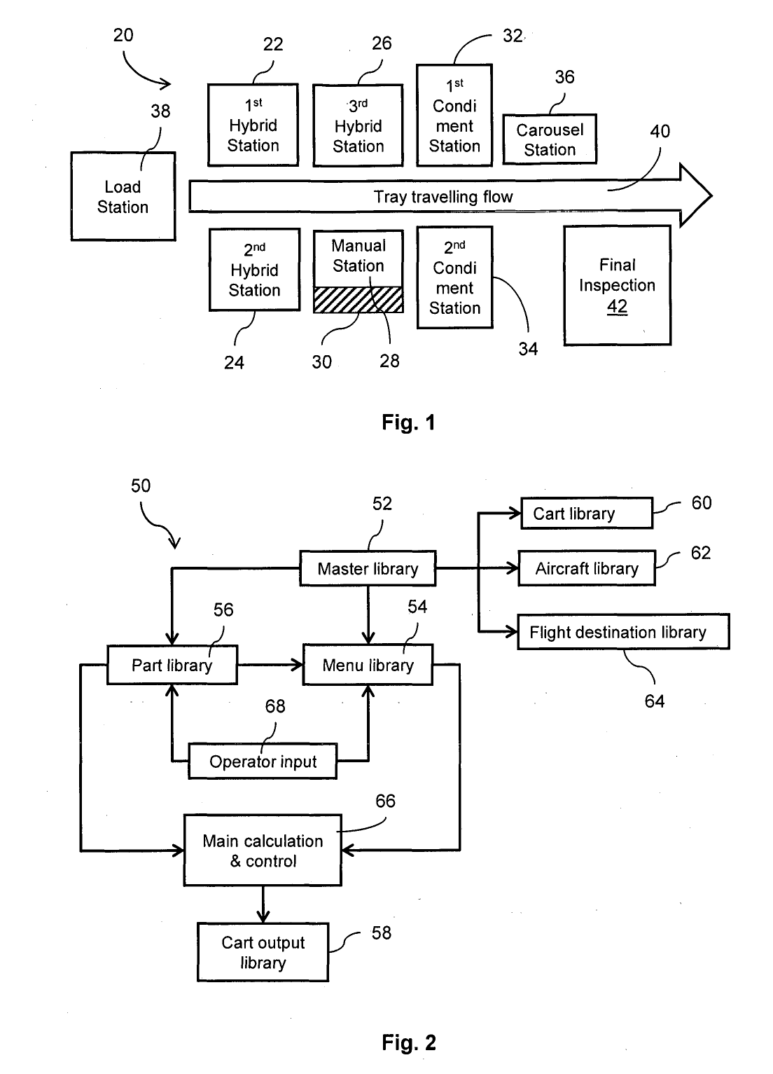

FIG. 1 illustrates a meal packaging line for preparing set meals in an inflight catering centre;

FIG. 2 illustrates a flow chart of data control for libraries of the meal packaging line;

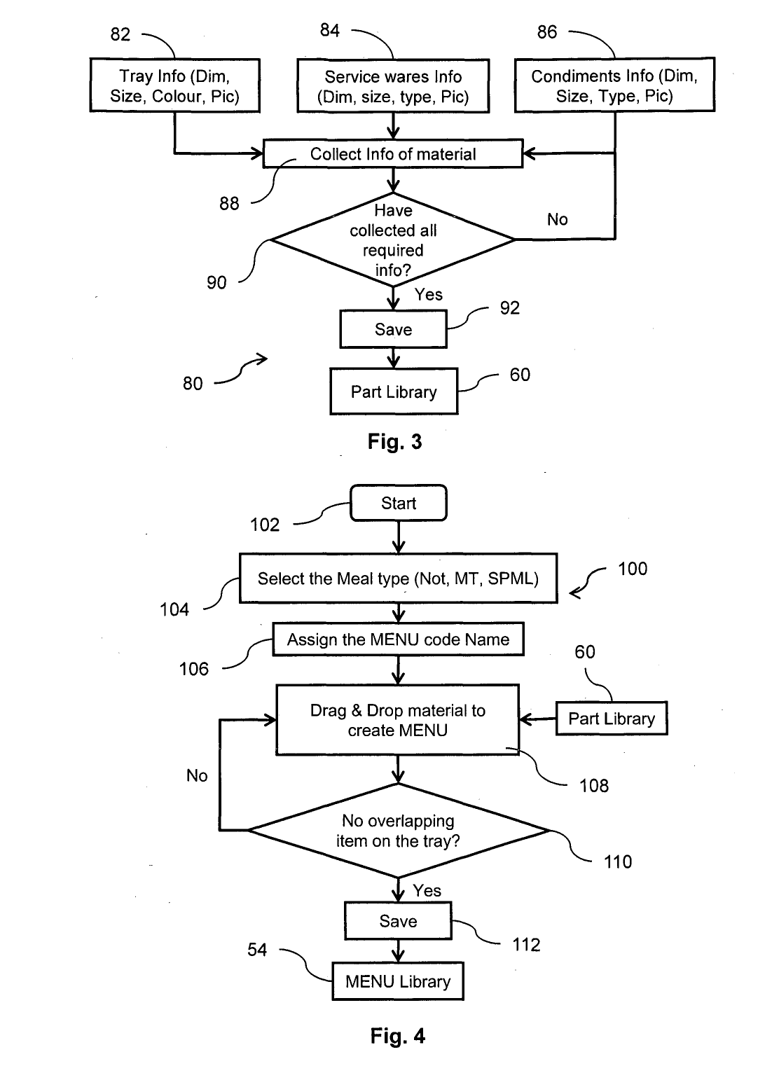

FIG. 3 illustrates a flow chart of data control for part library;

FIG. 4 illustrates a flow chart of data control for menu library;

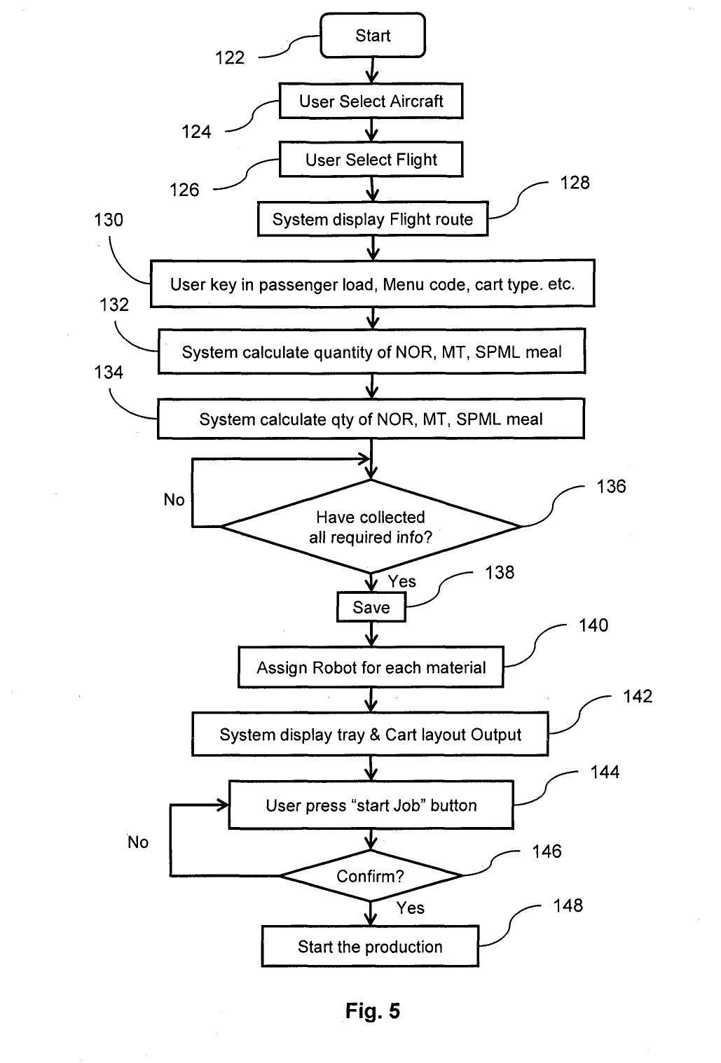

FIG. 5 illustrates a configuration process of the meal packaging line; and

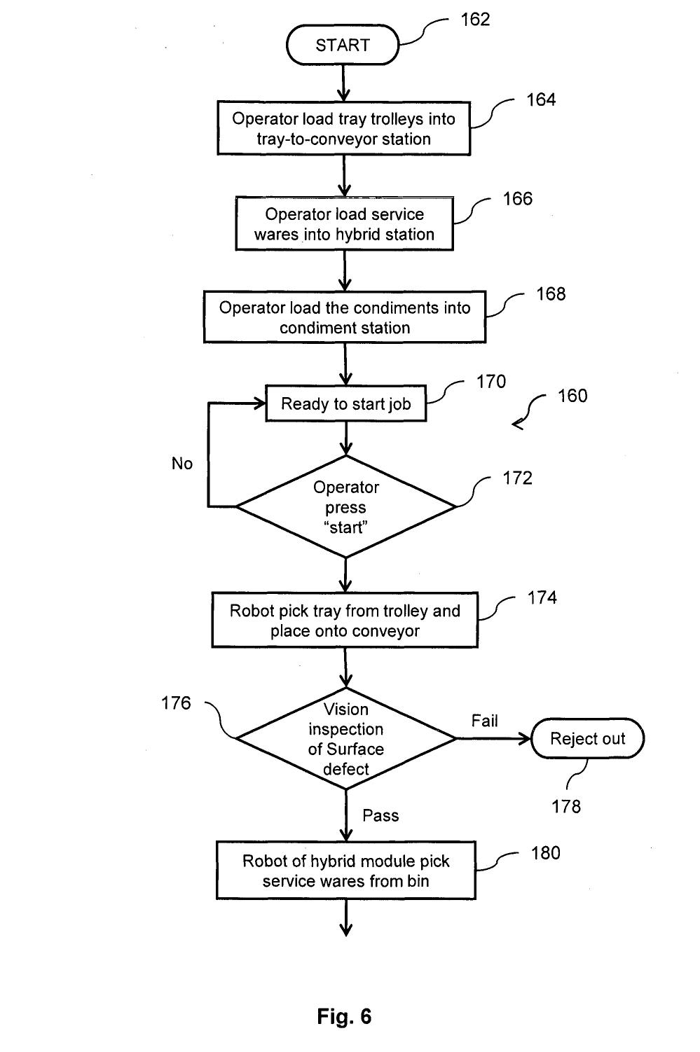

FIGS. 6 & 7 illustrate a method of packaging set meal by using the meal packaging line.

Exemplary, non-limiting embodiments of the present application will now be described with references to the above-mentioned figures. Description of these embodiments may involve parts that are identical or similar. The identical or similar parts are labeled with identical or similar reference numerals. Description of the identical or similar parts is therefore incorporated by reference wherever appropriate.

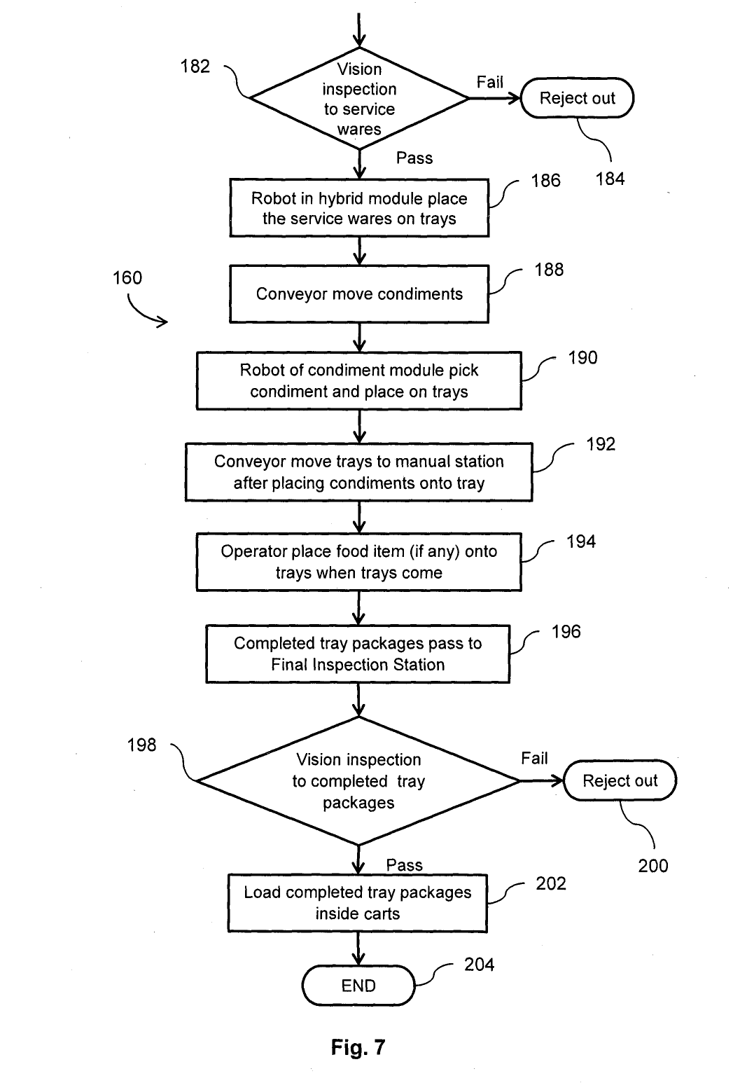

FIGS. 1 to 7 relate to an embodiment of the present application. In particular, FIG. 1 illustrates a meal packaging line 20 for preparing set meals 22 in an inflight catering centre 24. The set meals 22 of a flight include following different types.

1. Medical meals
a. Diabetic Meal
b. Low Calorie Meal
c. Bland Meal
d. Vegetarian lacto—Ovo Meal
e. Low Fat Meal
f. Low Purine Meal
g. Gluten Free Meal
h. Low Salt Meal
i. Low Lactose Meal
j. Low Protein Meal

2. Vegetarian Meals
a. Asian Vegetarian Meal
b. Vegetarian Vegan Meal
c. Vegetarian Meal
d. Vegetarian Oriental Meal

3. Children Meals
a. Child Meal
b. Baby Meal

4. Religious Meals
a. Moslem Meal
b. Kosher Meal
c. Vegetarian Jain Meal
d. Hindu Meal

5. Other Meals
a. Fruit Platter Meal
b. Non Vegetarian Meal
c. Sea Food Meal
d. Continental Meal
e. Hearty Breakfast Meal.

In detail, for example, the Hearty Breakfast Meal (i.e. item 5.e) contains hot food that contains an omelette, a chicken drum stick or wing, two sausages, crispy potato hash brown, salted button mushrooms and baked beans. The Hearty Breakfast Meal (5.e) further includes cold food that include two slices of bread, a bottle of juice and a cup of yogurt. In addition to cutlery items, these food and beverage items are packaged in a tray, whilst some of them (e.g. condiments) are further sealed in paper or plastic bags, such as pepper and salt sachets.

The meal packaging line 20 generally comprises several hybrid work stations and one manual work station that are aligned at opposite sides of a conveyor. Both the hybrid work stations and the manual work station handle different types of food and beverage items flexibly, which are listed above as items 1.a to 5.e. The hybrid work stations or manual work station may simply be known as hybrid stations or manual station respectively.

In detail, the meal packaging line 20 comprises a first hybrid station 22, a second hybrid station 24 and a third hybrid station 26 for loading small platters. The meal packaging line 20 also has a first condiment station 32 for picking salt sachets and a second condiment station 34 for loading pepper sachets. A carousel station 36 is located near an end of the meal packaging line 20, besides the first condiment station 32. A tray loading station 38 and a final inspection station 42 of the meal packaging line 20 are located at opposite ends of the conveyor 40. A manual station 28 is installed between the second hybrid station 24 and the second condiment station 34. According to FIG. 1, the first hybrid station 22, the third hybrid station 26, the first condiment station 32 and the carousel station 36 are sequentially aligned next to the conveyor 40. Similarly, the on an opposite side the conveyor 40, the second hybrid station 24, the manual station 28, the second condiment station 34 and the final inspection station 42 are consecutively aligned from an inlet of the conveyor 40 to an outlet of the conveyor 40. The load/loading station 38 is positioned at the inlet of the conveyor 40, whilst carts (not shown) queue at the outlet of the conveyor 40.

Particularly, the meal packaging line 20 has a computing server 30 that is attached to the manual station 28. The computing server 30 has user interface peripheral equipment, such as touchscreen(s), printer(s)/plotter(s), keyboard(s), writing pad(s) and computer mouse(s) (not shown). The computing server 30 further has wired communication ports, such as Digital Visual Interface (DVI), DsiplayPort (e.g. USB), E-Sata, Firewire (IEEE1394), serial, PS/2, USB, VGA, SCSI, HDMI, Ethernet port and audioport. The computing server 30 additional has wireless adapters for communication via 3G (third generation of mobile telecommunications technology), 4G LTE (Long-Term Evolution), 4G (fourth generation of mobile telecommunications technology), Wi-Fi (IEEE 802.11 standards), Bluetooth (2.4-2.485 GHz) and ZigBee (IEEE 802.15.4 standard). Hence, the computing server 30 is connected to both intranet and internet via cables and/or wireless communication. Stations 22-28, 32-42 and conveyors 40 of the set meal packaging line 30 are connected to the computing server 30 via cables and/or wireless communication (not shown).

Except the manual station 28, each station of the set meal packaging line 20 has a six-axes industrial robot (not shown) and camera (not shown) that are connected to a local computer (not shown) and the computing server 30. The camera provides machine vision with 2D visible light and/or 3D visible light to end effectors of the industrial robots. The end effectors include impactive, ingressive, astrictive and contiguitive types respectively. These industrial robots are either floor-mounted or ceiling-mounted to their respective stations such that these industrial robots may be simply known as stations.

FIG. 2 illustrates a flow chart 50 of data control for the meal packaging line 20. The data control involves local databases that are libraries inter-connected. These libraries are stored and managed by the computing server 30. In detail, the libraries include a master library 52, a menu library 54, a part library 56 and a cart output library 58. The master library 52 further includes cart library 60, aircraft library 62, flight destination library 64. In addition to the libraries, the computing server 30 has an application software package known as main calculation and control logic 66, which enables an operator/user 68 to design, configure, update and store various types of set meal packages.

Particularly, the cart library 60 includes information of quantity, type, electronic identities of set meal carts of a flight catering centre near an international airport. The aircraft library 62 has data on various aircrafts that arrive and depart from the international airport. The data specifically include information on seats (e.g. business class or economic class) of these various aircrafts. The flight destination library 64 has figures on destinies and origins of relevant flights, flight durations information and time (e.g. departure and arrival) of these relevant flights. Accordingly, the master library 52 provides user requirements for set meal packaging with reference to flights and catering equipment (e.g. cart) of these flights.

The menu library 54 stores data from the inflight catering centre on various food menus. The menu library 54 has detailed information of meals, deserts, beverages and condiment such that items selected from the menu library 54 can be prepared and assembled into set meal packages for catering to the flights. Similarly, the part library 56 has information on food catering service ware items, including shapes, sizes, quantities and weights of various containers. Typical food catering service ware items include trays, cups, bottles, saucers, dishes and mugs. The cart output library 58 comprises diverse types of cart configurations. The cart library includes carts that have layers of different packaged set meals, column(s) of fully or partially filled packaged set meals, which are prepared for various aircrafts or airlines.

The cart output library is derived and store information based on passenger's meal orders and airlines' catering/food options. The cart library further has records on carts of various airlines such that the passengers' meal orders are automatically prepared by various packaged set meals, and distributed to the various carts specifically. Completed or packaged carts (i.e. carts filled with packaged set meals) are further transported to designated aircraft galleries near passengers' seats.

FIG. 3 illustrates a flow chart 80 of data control for the part library 60. As mentioned earlier, the part library 60 has tray information 82, service ware information 84 and condiments information 86. The tray information 82 provides dimensions, colours, images/pictures and other physical characteristics of various meal trays that are used by the inflight catering centre. The service ware information 84 offers sizes, colours, weights, translucency and other physical characteristics of numerous service ware items, such as cups, glasses and saucers. The condiments information 86 contains information on dimensions, types, portraits and other physical characteristics of condiments, such as nut sachets and biscuit packs. In use, the operator 68 selects one or more types of trays, picks service ware items and choose condiments from the part library 60. Upon collecting 88 the information, the main calculation & control logic 66 requires the operator to verify 90 if the selections 82, 84, 86 are complete. Once confirmed, the operator 68 saves/records 92 the information on the selections into the part library 60, which is on the computing server 30.

FIG. 4 illustrates a flow chart 100 of data control for the menu library 54. According to the flow chart 100, the operator 68 starts 102 by opening the menu library 54. The operator 68 then selects 104 a designated meal type from the existing menu library 54, such as an Asian Vegetarian Meal (2.a). All types of set meals have their unique identification codes such that the chosen set meal is assigned 106 with a menu code name (e.g. AVM). The menu code name may be a new code if no existing set meals satisfy the operator's requirements. In the present case, the operator 68 uses graphical user interface of the main calculation & control logic 66 such that she chooses service ware items, food types and beverage choices by dragging and dropping selected objects into a graphically represented tray for creating 108 a new menu. Both the main calculation & control logic 66 and the operator 68 subsequently examine 110 a graphical representation of a packaged set meal to ensure that there is no overlapping of various items on the tray (not shown). If overlaying of objects is observed, the operator 68 is prompted to relocate or modify the set meal. If no shrouding is found by either the main calculation & control logic 66 or the operator 68, the operator 68 then saves 112 the set meal configuration into the menu library 54.

FIG. 5 illustrates a configuration process 120 of the meal packaging line 20. The operator 68 starts 122 by selecting 124 a type of aircraft from the aircraft library 62. The operator 68 further chooses 126 a flight number/code that relates to the selected type of aircraft. The computing server 30 then retrieves and displays 128 flight route 128 of the flight number. Based on the displayed aircraft seating arrangement, the operator 68 keys/enters in 130 passenger load(s), menu codes, cart type and other meal catering information to the computing server 30. The application software (main calculation & control logic) 66 performs calculation for allocating food, beverage service ware items, serviettes and condiments to various types of set meals of the flight. The computing server 30 will automatically perform self-examination 136 and notify the operator 68 if all required information has been provided for completing the configuration of set meals. Graphical images and parameters of configured set meals are displayed and listed for review by the operator 68. These parameters include calories, dietary restriction and nutrition information of the set meals. Upon acceptance and confirmation, the operator subsequently saves 138 the information of meal set configuration for following operations.

The following operations include that the operator 68 assigns 140 each industrial robot for handling specific food, beverage or service ware items. For example, the load station 38 is assigned to pick empty and clean trays from bins onto the conveyor 40. An industrial robot 38 of the load station 38 further examines surface integrity (e.g. hygiene and free of sharp edges) of each tray such that the load station 38 only put quality-compliant trays onto the conveyor 40 sequentially. The first 22, second 24 and third 26 hybrid stations are assigned to put service ware items (e.g.

cups, mugs and dishes) onto trays respectively. Of course, the service ware items are subjected to scrutiny by machine vision of these industrial robot's 22, 24, 26 such that quality non-compliant items are disserted into refuse neighbouring bins of these stations 22, 24, 26. In contrast, the first and second condiment stations 32, 34 load sachets of tomato ketchup, pepper, salt, butter and sugar to designated places on the trays respectively. At the carousel station 36, an industrial robot 36 transfers a casserole of food items (e.g. sushi, bread, fish slices, pancake, or duck meat). At the end of the set meal packaging line 20, the final inspection station 42 captures images of packaged set meals, and compares them with standard images in libraries of the computing server 30. Quality non-compliant meal sets, which include punctured packages, spilled food or drinks, are discarded into a recycle bin for manual examination or handling. If the packaged meal sets are found to be acceptable, the industrial robot of the final inspection station 42 automatically transports the meal sets into meal carts, at the end of the set meal packaging line 20. Packed carts and removed, whilst empty carts automatically at the end of the set meal packaging line 20 by cart handling machinery or unmanned vehicles (not shown).

The computing server 30 displays 142 tray and cart layout as output after assigning relevant jobs to each of the industrial robots 38, 22, 24, 26, 32, 34, 36, 42. The operator 68 then press down a “start job” button on the touchscreen of the computing server 30. The set meal packaging lines performs self-examination 146 subsequently to ensure that there the entire set meal packaging line 20 is ready. The self-examination 146 includes checking if there sufficient food, beverage and service ware items and if the industrial robots are operationally ready, including their cameras. Once confirmed 146 by the self-examination process, the set meal packaging line 20 then starts operation by packaging the set meals according the operator's configurations. The set meal packaging line has sensors such that the set meal packaging line 20 set off alarms when requiring operator's intervention.

FIGS. 6 & 7 illustrates a method, manufacturing process or packaging procedure 160 of packaging set meals by using the meal packaging line 20. In the beginning, the operator or user 68 starts 162 the manufacturing process 160 by pushes 164 tray trolleys (not shown) into a receiving bay of the tray-to-cart load station 38. The tray-to-cart station 38 is also known as tray-to-conveyor or tray-to-conveyor module 38. The operator 68 further loads 166 service ware items to the hybrid stations 22, 24, 26 so that the industrial robots 22, 24, 26 of hybrid stations 22, 24, 26 can transfer the service ware items (e.g. cups, mugs and dishes) to trays on the conveyor 40. For example, the first hybrid station 22 receives saucers for holding cups or mugs. The second hybrid station 24 accepts plates for keeping vegetables. The third hybrid station 26 takes packaged cutlery packages, including chopsticks. Subsequently, the operator 68 places sachets of pepper and salt into the first condiment station 32, whilst provides small packs of sugar and butter into the second condiment station 34.

After completing the loading of food, beverage and service ware items to various stations of the set meal packaging line 20, the operator 68 will examine every station to check 170 if the set meal packaging line 20 is ready to run. The computing server 30 will perform routine check (self-examination) of the set meal packaging line 20 to ensure machine status. For example, sensors (not shown) of the set meal packaging line 20 measures if there is sufficient stock (e.g. butter or cutlery packages) for at least 2 hours of automatic packaging operation. If both the operator 68 and the computing server 30 are satisfied, the operator presses a “start-button” 172 for initiating the manufacturing process.

After the initiation, the industrial robot 38 (i.e. tray-to-conveyor load station) picks 174 a tray from a trolley and places 174 the tray onto the conveyor 40. The tray loading station 38 has cameras that perform machine vision inspection 176 to the tray. The machine vision examines 176 profile integrity and surface cleanness of the tray such that quality-compliant trays have no crack, no chip off, no deep scratch and no soil. If the tray is found to have food stain on its surface, the soiled tray will be rejected 178 and casted 178 into a reject bin (not shown). In contrast, if the tray is found to be compliant with quality requirements, the tray passes the vision inspection and is laid onto the conveyor 40.

Machine vision of the first hybrid station (industrial robot) 180 detects and locates incoming trays on the conveyor 40. Once identifying the incoming tray, the first hybrid station 22 picks 180 a service ware item (e.g. pasta bowl) from its bay (storage place of the first hybrid station). When passing through a camera (not shown) of the first hybrid station 22, the camera performs machine vision examination 182 to the service ware item. If the service ware item is found to be not complaint with predetermined quality requirements, the service ware item is ejected 184 into a bin (not shown) at the first hybrid station 22. In contrast, if the service ware item fulfils relevant quality requirements, the service ware item will pass the vision inspection such that the first hybrid station 22 will place 186 the service ware item onto a tray.

Each of the stations has a transporter (not shown), also known as conveyor. Transporters of the stations arrange, sort and feed respective item to the industrial robots. For example, a transporter of the first condiment station spread salt in white sachets and pepper in brown sachets apart so that its industrial robot picks 190 a salt sachet and a pepper sachet for placing 190 onto every tray on the conveyor 40.

After placing condiments (e.g. salt), side-dishes (e.g. salad), cutlery pack, biscuit package and beverage (cup water) on to the tray, the conveyor 40 moves 192 the tray to the manual station 28 so that the operator 68 places 194 additional food items onto the tray. If programmed or required, the first condiment station 32, the second condiment station 34 and the carousel station 36 continue to load food and beverage items onto the tray. Particularly, the carousel station 36 places food items of odd shapes or soft body (e.g. Toblerone™ chocolate of triangular prism, ice-cream of softball) in carousels onto trays respectively.

The final inspection station 42 has cameras of different angles and height for vision-inspecting all incoming set meal packages. For example, the cameras capture an aerial view and four side views of a packaged set meal on the tray and compare captured images with standard images in the libraries of the computing server 30. If the packaged set meal fails to comply with predetermined quality standards (e.g. water spillage), the failed set meal package will rejected 200 and purged into a bin for manual handling. An alarm is set off for getting attention of the operator 68. In contrast, if the packaged meal set fulfill the predetermined quality standards (e.g. the aerial view matches a stored image), the industrial robot 42 of the final inspection station 42 will grasp 202 the packages set meal and move 202 the completed set meal package into a lot of a (meal) cart. The cart will thus be gradually filled up with packaged set meals. An empty cart will replace a filled cart by a transporter of the final inspection station according to predetermined programme. The set meal packaging line 20 ends 204 its operation once sufficient number of set meal packages have been placed into the carts.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

20 set meal packaging line
22 first hybrid station
24 second hybrid station
26 third hybrid station
28 manual station
30 computing server
32 first condiment station
34 second condiment station
36 carousel station
38 tray loading station
40 conveyor
42 final inspection station
50 flow chart
52 master library
54 menu library
56 part library
58 cart output library
60 cart library
62 aircraft library
64 flight destination library
66 main calculation and control logic
68 operator
80 flow chart
82 tray information
84 service ware information
86 condiments information
88 collect information of material
90 verify
92 save
100 flow chart
102 start
104 select meal type
106 assign menu code name
108 create menu
110 examine
112 save
120 configuration process
122 start
124 select aircraft
126 select flight
128 display flight route
130 enters passenger load, menu code. cart type
132 calculate quantities of different types of meals
136 check if all required information has been collected
138 save
140 assign robot to each item
142 display tray and cart layout
144 press “start job” button
146 self-examination
148 start production
160 manufacturing process
162 start
164 load tray trolley(s) into tray-to-conveyor station
166 load service ware items into hybrid stations
168 load condiments into condiment station(s)
170 check if ready to start set meal packaging
172 press start button
174 pick tray from trolley and place onto conveyor
176 vision inspection
178 reject
180 pick service ware items from bin
182 vision inspection
184 reject
186 place service ware items onto trays
188 move condiments
190 pick and/or place condiment onto trays
192 move trays
194 place food items onto trays
196 pass through final vision inspection station
198 vision inspection
200 reject
202 load completed tray packages into carts
204 end

1. Method of packaging set meals for inflight dining, the method comprising:
providing service ware items,
offering food, beverage or condiment items,
preparing at least one configuration of set meal package, and
assembling a set meal package according to the configuration automatically.

2. Method of claim 1, wherein preparing at least one configuration of set meal package comprises storing identification information of the at least one configuration of set meal package.

3. Method of claim 2, wherein storing identification information of the at least one configuration of set meal package comprises keeping identification codes of the set meal package, service ware items of the set meal package, food items of the set meal package, beverage items of the set meal package, condiment items of the set meal package, cutlery items of the set meal package or a combination of any of these.

4. Method of claim 2, wherein storing identification information of the at least one configuration of set meal package comprises preserving graphic images of the set meal package, service ware items of the set meal package, food items of the set meal package, beverage items of the set meal package, condiment items of the set meal package, cutlery items of the set meal package or a combination of any of these.

5. Method of claim 1, wherein preparing at least one configuration of set meal package or storing identification information of the at least one configuration of set meal package comprises establishing at least one digital library for keeping relevant information.

6. Method of claim 5, wherein the at least one digital library comprise a master library, a tray items library, a menu library, a cart output library, a cart library, an aircraft library, a flight destination library or a combination of any of these libraries.

7.-8. (canceled)

9. Method of claim 1, further comprising
transferring the at least one meal package to a cart according to flight information, aircraft information or seating information of a flight.

10. Method of claim 1, further comprising
inspecting at least one item of the set meal package automatically.

11. (canceled)

12. Method of claim 10, wherein the inspecting further comprises examining the at least one item of the set meal package or an assembled set meal package by machine vision or computer vision.

13.-16. (canceled)

17. Method of claim 1, further comprising
refusing at least one of service ware items, food items, beverage items, condiment items or cutlery items for assembling the set meal package if found quality non-compliance by the machine vision or computer vision.

18.-29. (canceled)

30. Set meal packaging line for inflight dining, the set meal packaging line comprising
at least one machine station for loading food, beverage, condiment or cutlery items onto a tray automatically,
at least one conveyor for transferring the food, beverage, condiment or cutlery items,
wherein the at least one machine station comprises an industrial robot.

31. Set meal packaging line of claim 30, further comprising,
a labeling station for attaching identification information to a packaged set meal or cart.

32. Set meal packaging line of claim 30, wherein the industrial robot has six degrees of freedom.

33. Set meal packaging line of claim 30, further comprising
at least one camera for capturing images of the food, beverage, condiment or cutlery items, or the tray.

34. Set meal packaging line of claim 30, further comprising
a computing server for examining the images of the food, beverage, condiment or cutlery items, or the tray against quality requirements.

35. Set meal packaging line of claims 34, wherein
the computing server is connected to the industrial robot for picking food or non-food items when assembling set meal packages according to at least one predetermined set meal package configuration.

36. Set meal packaging line of claim 34, wherein
the computing server comprises at least one communication port for wired or wireless configuration with intranet or internet.

37. (canceled)

38. Set meal packaging line of claim 30, further comprising
a manual work station for assembling the set meal package.

39. Set meal packaging line of claim 30, further comprising
a labeling station for attaching at least one label to a packaged set meal, a cart or both according to passenger or flight information.

40. Set meal packaging line of claim 30, further comprising
a biosensor for monitoring hygiene condition of the set meal packaging line.
